(19) United States
(12) Patent Application Publication
(10) Pub. No.: US 2011/0100072 A1
(43) Pub. Date: May 5, 2011

(54) SECURITY DEVICE

(76) Inventors: Sean Christopher Rackley, Oxfordshire (GB); Timothy Dean Baston, Oxfordshire (GB)

(21) Appl. No.: 13/000,626

(22) PCT Filed: Jun. 22, 2009
(86) PCT No.: PCT/GB2009/001541

§ 371 Date: Dec. 21, 2010

(30) Foreign Application Priority Data
Jun. 23, 2008 (GB) 0811431.6

(51) Int. Cl. E05B 67/06; E05B 67/00; E05B 73/00

(52) U.S. Cl. 70/49; 70/20

(57) ABSTRACT

A security device for making secure an item includes an engaging element for securing to a part of the item, which has a device for attaching the engaging element to a flexible elongate member, which may be extended from a reel. The reel includes a device for the flexible elongate member, having been attached to the engaging element, to be secured to the reel for providing a closed loop. The security device may be used, for example, to secure poles in scaffolding assemblies.

### FIELD OF THE INVENTION

The invention relates to devices for increasing the security of objects and equipment which might be vulnerable to being removed without the permission of the owner, including by theft.

Equipment which is of value may be stored in many different places, for example, houses, sheds, garages, stables and motor vehicles. In addition, items not stored within anything else may themselves be subject to removal without permission, examples being caravans, boats and scaffolding pole assemblies.

### BACKGROUND TO THE INVENTION

Very many items are prone to loss through removal without permission including as a result of theft. By way of example, assemblies of scaffolding poles, including scaffolding towers, are particularly prone to loss of poles through theft or as, for instance, the result of the need for use of one or more poles on a temporary basis in another location.

### STATEMENTS OF THE INVENTION

According to the present invention, there is provided a device for making secure an item, the device comprising a plurality of item engaging elements, each for securing to a part of the item and having means for attaching said element to a flexible elongate member, and reel means providing a desired length of flexible elongate member which may be extended from said reel means and attached to each engaging element, said reel means having means whereby the flexible elongate member, having been attached to the engaging elements, may be secured to the reel means to provide a closed loop.

Preferably, the flexible elongate member is a metal cable.

Preferably, the metal cable is a braided steel wire.

Preferably, the reel means comprises a housing and, mounted within the housing, a cable drum.

Preferably, the reel means comprises a locking device for securely receiving the end of the flexible elongate member.

Preferably, the end of the flexible elongate member is provided with a bullet lock profile for inserting into said locking device.

Preferably, the locking device is provided with a removable key for operating said device.

Preferably, the device includes means for transmitting a signal if the device is disturbed when it is in a securing mode.

Preferably, the signal transmitting means are located within the housing which also comprises the reel means. Also located in the housing is means for providing power to the signal transmitting means, for instance, a long life battery.

### BRIEF DESCRIPTION OF THE DRAWINGS

FIG. 1 is a side view of reel means forming part of a first embodiment of the invention;

FIG. 2 is an end view of the reel means of FIG. 1;

FIG. 3 shows a pole engaging element forming part of a device of the invention;

FIG. 4 shows a device of the invention, in use in connection with a scaffolding tower;

FIG. 5 shows a vault unit for use with a device of the invention; and

FIG. 6 is a perspective view of a second embodiment of the invention.

### DETAILED DESCRIPTION OF THE INVENTION

The present invention will now be described, by way of examples only, with reference to the accompanying drawings. Although the invention will be described with reference to its use in securing the poles of a scaffolding assembly, it should be appreciated that the device may be used in very many other situations, as outlined above.

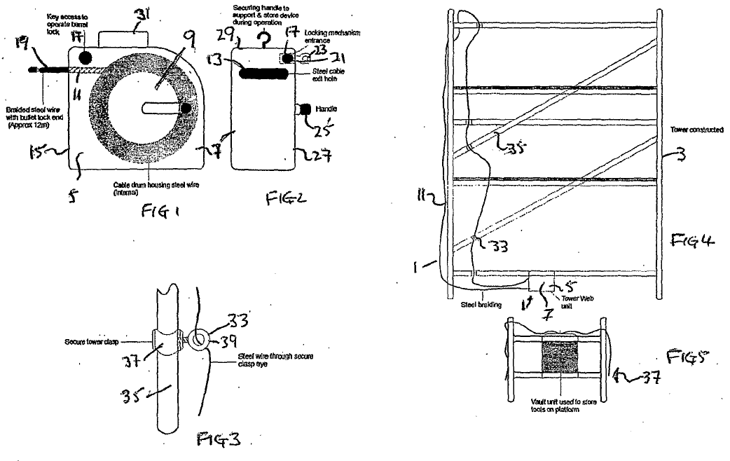

Referring to FIGS. 1 to 5 of the accompanying drawings, a device 1 in accordance with the present invention is for securing together one or more poles of a scaffolding assembly such as a scaffolding tower 3. The purpose of the device is to allow the tower to be secured in position and to ensure that all the relevant sections are kept together. As a result, the scaffolding tower is rendered relatively secure, and there are advantages in the areas of health and safety and in general productivity.

Referring more particularly to FIGS. 1 and 2 of the accompanying drawings, the device of the invention includes a cable reel 5 which includes a housing 7 and, mounted within the housing, a cable drum 9. Wound around cable drum 9 is a braided steel wire 11, which has a length of approximately 12 m. Steel wire 22 exits from housing 7 through exit hole 13 located in an end 15 of the housing. The housing 7 is also provided with a locking device 17, which enables the steel cable 11 to be looped back to the reel 5. This is achieved by inserting the end 19 of steel cable 11 into entrance hole 21 of locking device 17. The end 19 of steel cable 11 is profiled to a bullet shape, which enables the end of the cable 11 to be secured in position within locking device 17 and securely locked in place by means of key 23.

The housing 7 of cable reel 5 also includes a handle 25 located on one side 27 of housing 7. In addition, the upper surface 29 of housing 7 is provided with a securing handle 31 to support and secure the device during operation.

Referring to FIG. 3 of the accompanying drawings, the device of the invention includes pole engaging elements 33 each of which is for attachment to a scaffolding pole 35. Element 33 includes a clasp 37 which, as illustrated, is securely fastened about pole 35. Element 33 also includes a clasp eye 39 which extends naturally from the clasp 37. In use, the steel cable 11 is threaded through clasp eye 39 in order to attach the cable to element 33.

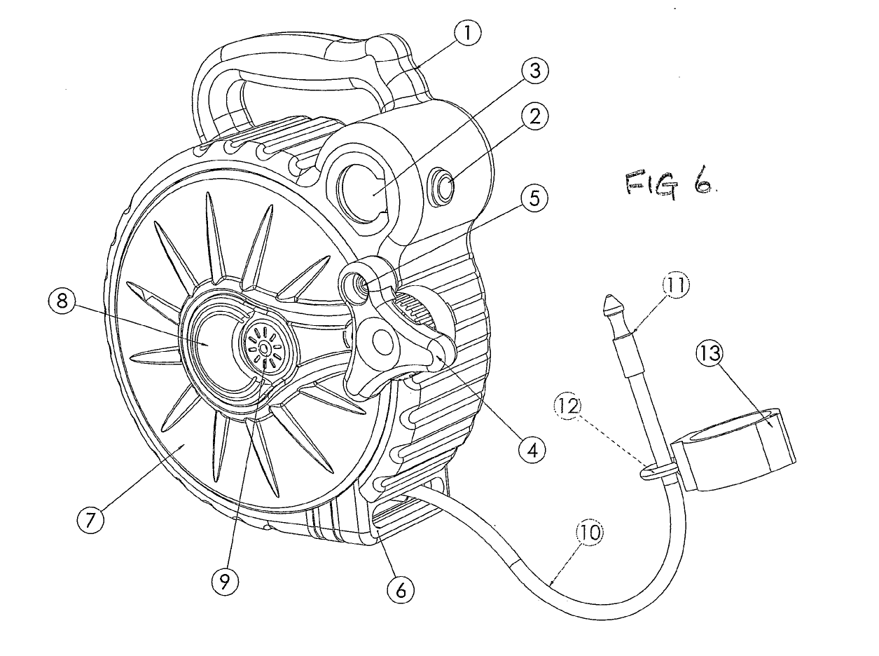

Referring to FIG. 4 of the accompanying drawings, there is illustrated the use of the above described device for securing together scaffolding poles 35 of a scaffolding tower 3. The cable reel 5 is located at the bottom of the tower 3 and the steel cable 11 is extended from housing 7 so as to pass through the clasp eye of each of the pole engaging elements 33. As illustrated, it can be seen that five scaffolding poles are secured together through the use of this device. There is, of course, no limit to the number of poles which can be secured in this way subject to the overall length of the steel cable 11.

The design of the above described device is based on the use of a retractable high tensile steel cable being drawn through secure clasps that are placed around the chosen section of the tower. This allows the tower to be secured to building fabric for storage in the assembled or disassembled mode. The clasp design is such that the clasps cannot be removed from their respective poles. Once the cable has been passed through all the clasps, the steel wire is locked into the housing of the cable reel to form a secure loop, Referring to FIG. 5 of the accompanying drawings, a vault unit 37 can be used to hold and store general tools while working on the scaffolding tower. The vault can be locked using the steel cable to provide security for drills and tools. Furthermore, the vault unit can also serve as the storage case for the complete device of the invention.

In another embodiment of the present invention, the device is substantially as described above with reference to the accompanying drawings. However, located within housing 7 is an electronic transmission device together with a power source, such as a long life battery. The electronic transmission device is arranged such that, if the device is in any way attacked or removed from its position, then the transmission device will be activated and a signal sent which indicates that such tampering or removal is taking place.

The signal may be any suitable signal, for instance electro-magnetic or sound. Receiving means may be required to detect the signal.

An alarm may be located either within housing 7 or remote therefrom. In the latter case the alarm may be activated by the signal from the signal transmitting means.

The signal transmitting means is armed by the locking of the device and disarmed when the device is legitimately disengaged from the item being protected.

A device having signal transmitting means may be provided with a higher degree of cable protection. Furthermore, a device of the present invention may be of stout construction including an ability to withstand all weather conditions.

Referring to FIG. 6 of the accompanying drawings, a second embodiment of the invention includes a main body having a handle 1 for use when retracting the cable and for hanging the device from a scaffolding tower. Integral with the housing 7 is a lock 2 for retaining the ferrule end of the cable and a lock housing 3 for locking the cable end when in position.

The device is provided with a winding handle for use in retracting the cable. Bullet lock 5 is used to prevent further cable being pulled out of the housing 7.

Cable 10 is a 12 m length of ⅚ mm braided steel cable sheathed in high vis plastics. The cable is withdrawn from the housing 7 through cable outlet 6.

Cable 10 is provided with a locking ferrule 11 which is formed of stainless steel and which can be locked into the lock 2.

The cable is provided with an eyed shackle 12, which has a shackle body 13 which can be opened to place around a tower pole having a diameter of 50 nm. When the eyed shackle is closed around a tower pole, the cable can be passed through, thus preventing the removal of the pole.

Drum housing 7 includes a drum centre 8 which houses a PCB, a pezo sounder, a battery and a loom. Furthermore, a GSM signaller may be installed within the drum centre. The pezo sounder 9 is capable of omitting 110 db sound.

1-11. (canceled)

12. A security device for making an item secure, comprising:
an item engaging element for securing to a part of the item;
a flexible elongate member;
means for attaching said item engaging element to said flexible elongate member; and,
a reel for providing a desired length of said flexible elongate member extending from said reel and attached to said item engaging element, said reel having means for securing said flexible elongate member, having been attached to said item engaging element, to said reel for providing a closed loop.

13. The security device for making an item secure according to claim 12, wherein said item engaging element comprises a clasp portion for at least partially embracing and securing to an item.

14. The security device for making an item secure according to claim 12, wherein said item engaging element comprises an eye portion through which said flexible elongate member is able to be threaded for providing engagement between said item engaging element and said flexible elongate member.

15. The security device for making an item secure according to claim 12, further comprising additional item engaging elements.

16. The security device for making an item secure according to claim 12, wherein said flexible elongate member is a metal cable.

17. The security device for making an item secure according to claim 16, wherein said metal cable is a braided steel wire.

18. The security device for making an item secure according to claim 12, wherein said reel comprises a housing and, mounted within said housing, a cable drum.

19. The security device for making an item secure according to claim 12, wherein said reel means comprises a locking device for securely receiving an end of said flexible elongate member.

20. The security device for making an item secure according to claim 19, wherein said flexible elongate member includes a bullet lock profile for inserting into said locking profile.

21. The security device for making an item secure according to claim 20, wherein said locking device includes a removable key for operating said security device.

22. The security device for making an item secure according to claim 12, further comprising means for signaling tampering of said security device.
